(19) United States
(12) Patent Application Publication
(10) Pub. No.: US 2013/0030899 A1
(43) Pub. Date: Jan. 31, 2013

(54) SYSTEM AND METHOD FOR PREVENTING TERMINATION OF ONLINE TRANSACTION

(71) Applicant: Shane Ehlers, Merrick, NY (US)

(72) Inventor: Shane Ehlers, Merrick, NY (US)

(21) Appl. No.: 13/561,883

(22) Filed: Jul. 30, 2012

Related U.S. Application Data
(60) Provisional application No. 61/513,221, filed on Jul. 29, 2011.

(51) Int. Cl. G06Q 30/02; G06F 17/00

(52) U.S. Cl. 705/14.23; 715/234

(57) ABSTRACT

Programming a hidden area of a web page in the path of exit from the web page or browser, and activating a hyperlink to provide a user incentive to complete an online transaction when the user pointing device enters the hidden area and before a termination event. The hidden area can move with scrolling of the web page.

### RELATED APPLICATION

This application claims the benefit of U.S. Provisional Application No. 61/513,221, filed on Jul. 29, 2011, hereby incorporated herein in its entirety by reference.

### FIELD

The present disclosure relates generally to internet commerce and in particular the present disclosure relates to prevention of termination of online transactions.

### BACKGROUND

Nearly every computer user uses a web browser to access websites on the world wide web, commonly referred to as the internet. The internet is a huge sales platform, with a user being able to find nearly any good for sale. With the vast amount of information and the huge number of websites dedicated to sales alone, it is difficult to keep a user on a particular website before completing a transaction. It is simple for a user to navigate away from a website or to close the website by moving the cursor to a “back” button or to a button that closes the website entirely. Once the user leaves the website, the chances of a sale decrease.

Previous solutions for attempting to prevent a user from termination of a potential transaction before completion are intrusive to the user and require the user to actually try to terminate a communication session by clicking the close page (X) button on a web browser, typing another uniform resource locator (URL) into an address bar of the browser, or by closing the browser in any way before a message can be sent to the user. The user must actually attempt to terminate the transaction before any action is taken by prior art approaches. The user at that point has essentially left the web page before any prompt or message occurs.

For the reasons stated above, and for other reasons stated below which will become apparent to those skilled in the art upon reading and understanding the present specification, there is a need in the art for a less intrusive system and method for preventing a user from terminating an online transaction.

### BRIEF DESCRIPTION OF DRAWINGS

FIG. 1 is a view of a web site page on which embodiments of the disclosure may be practiced;

FIG. 2 is a view of a web site page on which embodiments of the disclosure may be practiced;

FIG. 3 is a view of a web page according to one embodiment of the present disclosure;

FIG. 4 is a view of a display according to one embodiment of the present disclosure;

FIG. 5 is a view of a web page showing an alternate positioning of a hidden area according to another embodiment of the present disclosure;

FIG. 6 is a view of a display according to one embodiment of the present disclosure;

FIG. 7 is a flow chart diagram of a method according to one embodiment of the present disclosure; and

FIG. 8 is a diagram of a computer system on which embodiments of the disclosure may be practiced.

### DETAILED DESCRIPTION

In the following detailed description of the embodiments, reference is made to the accompanying drawings that form a part hereof. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

The following detailed description is, therefore, not to be taken in a limiting sense, and the scope of the present disclosure is defined only by the appended claims, along with the full scope of equivalents to which such claims are entitled.

The embodiments of the present invention help persuade a user from terminating a communication session prior to completion of an on-line transaction.

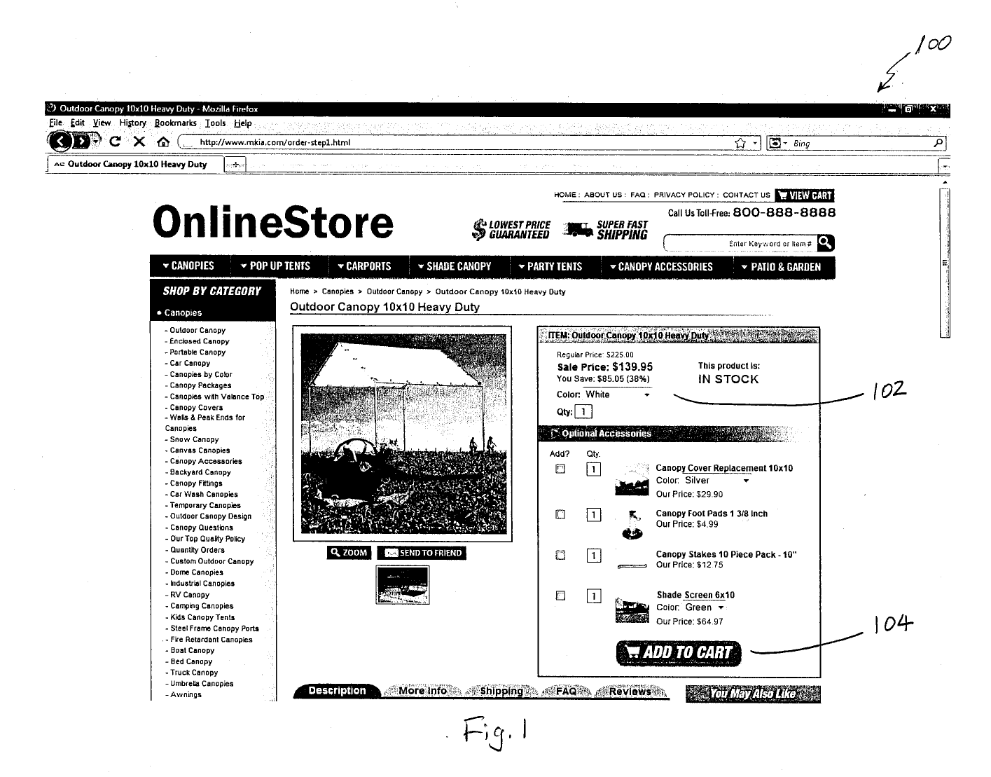

Referring to FIG. 1, a web page 100 on which embodiments of the present invention may be implemented is shown. An item 102 has been identified by a user for a potential purchase. The user adds the item to the online shopping cart by navigating to the item on the web site, and clicking the mouse on the “add to cart” button 104 on the web site 100.

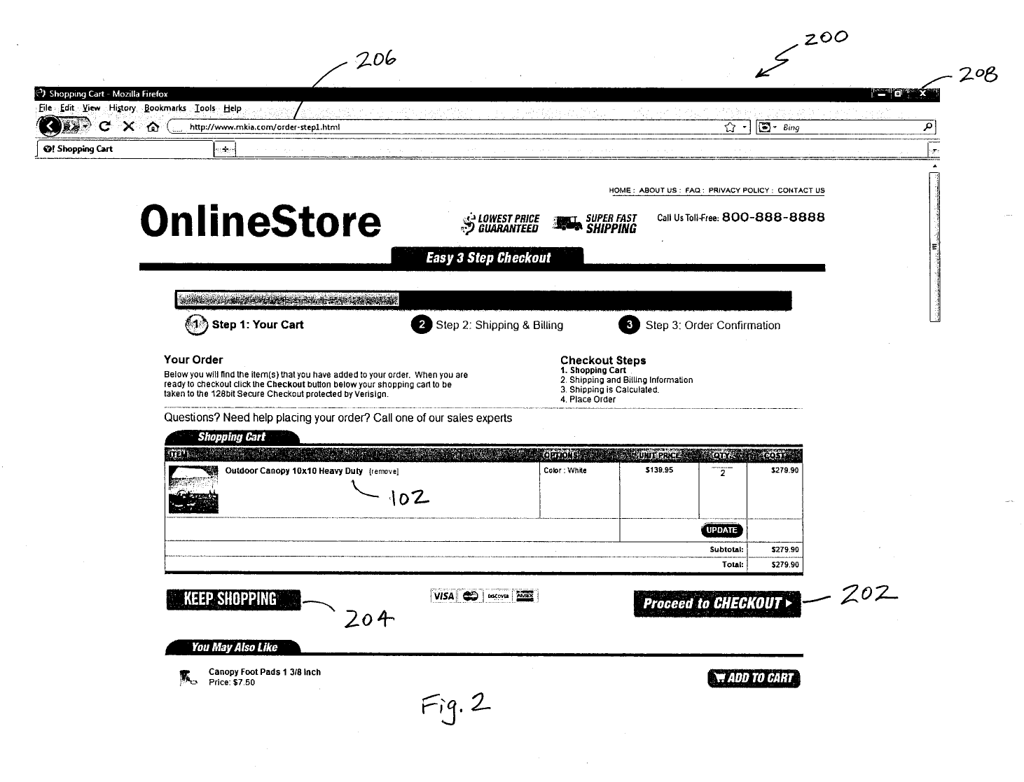

FIG. 2 shows a next page 200 that is displayed for the user when an item or items have been added to the online shopping cart, or the user decides to view the online shopping cart by clicking a direct link thereto. As is shown, the item 102 is present in the online shopping cart. At this point, the user has several options available. If the user is ready to complete the transaction for the selected item or items, the user can position the cursor over the “proceed to checkout” button 202 and go to the checkout process. If the user desires to look for additional items, the user can position the cursor over the “keep shopping” button 204 to return to shopping at the web site.

However, if the user decides at this point that he or she does not wish to complete the purchase, there are several options for the user. The user can close the browser using a series of key strokes designed to terminate operation of the current program. The user can type a new URL in the address bar 206 of the browser. The user can position the cursor over the close button (X) 208 usually located in the upper right hand corner of the web site screen. If multiple tabs on a browser are open, each individual tab usually has its own close button that may be used to close the particular tab. Each of these operations terminates the online transaction without completion of the sale.

In one embodiment of the present disclosure, a hidden area is positioned on an Internet web page. This hidden area contains a hyperlink that activates when a user pointer device (e.g., mouse cursor, touch pad cursor, etc...) rolls over the particular hidden area. When this occurs, the hyperlink is activated to present the user with a message in the web page or in the form of a pop-up window, telephone call, or e-mail containing an incentive to stay on the page, or to go back to the web page and possibly complete the transaction. The hidden area in one embodiment is positioned such that when a user engages in a mouse or other cursor movement that would appear to be an attempt to close the browser or enter a different URL in the address bar, the hidden hyperlink is activated. The position of the hidden area therefore depends on the position of the address bar and the “close” button, or any other closing link on the web page.

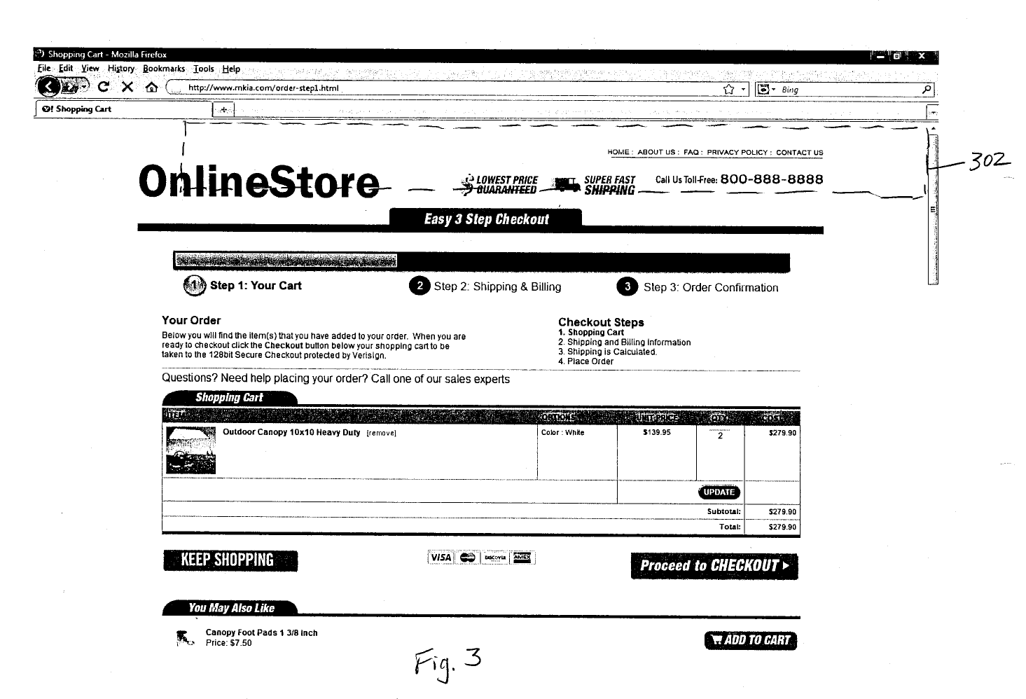

An example of a hidden area 302 is shown in dashed line form in FIG. 3. It should be understood that the size and location of the hidden area containing the hyperlink can be changed depending on the arrangement of the closing or changing locations for the browser or browser window. The hidden area containing the hyperlink can stretch from left to right and can be positioned at the very top of the web page viewing portion of the browser. The hidden area is in one embodiment positioned in the path of all exit points within the browser or browser window.

The hidden area in one embodiment follows the user dynamically as the web page is scrolled down, allowing the hidden area hyperlink to be activated on the top of the web page viewing portion at any time the user rolls the pointing device over the hidden area. More info; The message can be an incentive, coupon, special deal, confidence text, or any combination of messages using text, images or any kind of media to convince the customer to stay on the current web page and possible complete their on-line transaction.

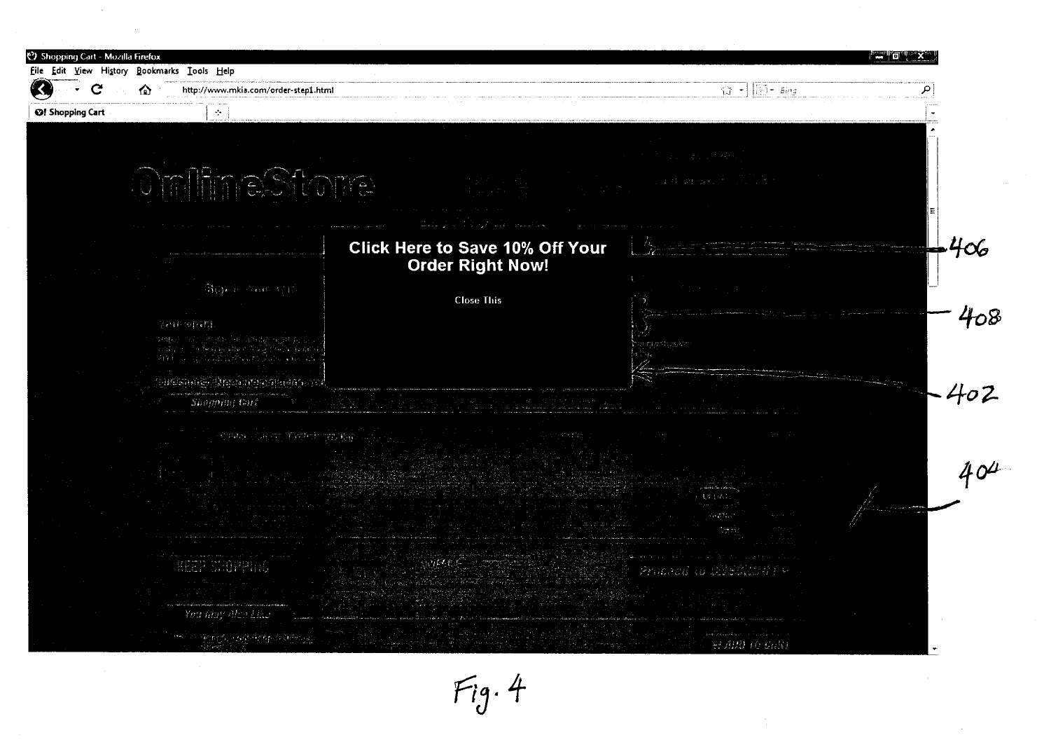

When a user moves the pointing device (e.g., mouse cursor, track pad or touch pad cursor, etc . . . ) into the hidden area 302, the hyperlink activates in one embodiment to display a discount coupon for items already present in the online shopping cart of the web site. This is accomplished before the user even reaches the browser controls, so the operation is performed before the user has actually attempted to terminate the transaction. An example of a message 402 displayed when the hidden area hyperlink is activated is shown in FIG. 4. In one embodiment, the remainder of the web page screen is shaded 404 and no mouse clicks are allowed outside of the message display within the web page. The user is given the option of applying an immediate discount to the order by clicking in one spot or area 406, or the option to close the message in a different spot or area 408.

It should be understood that the message being displayed may take many forms without departing from the scope of the disclosure. For example, a discount offer may be contained in the message, or an invitation to some other incentive, coupon, special deal, confidence text, or any combination of messages using text, images or any kind of media to attempt to persuade the user to complete the transaction.

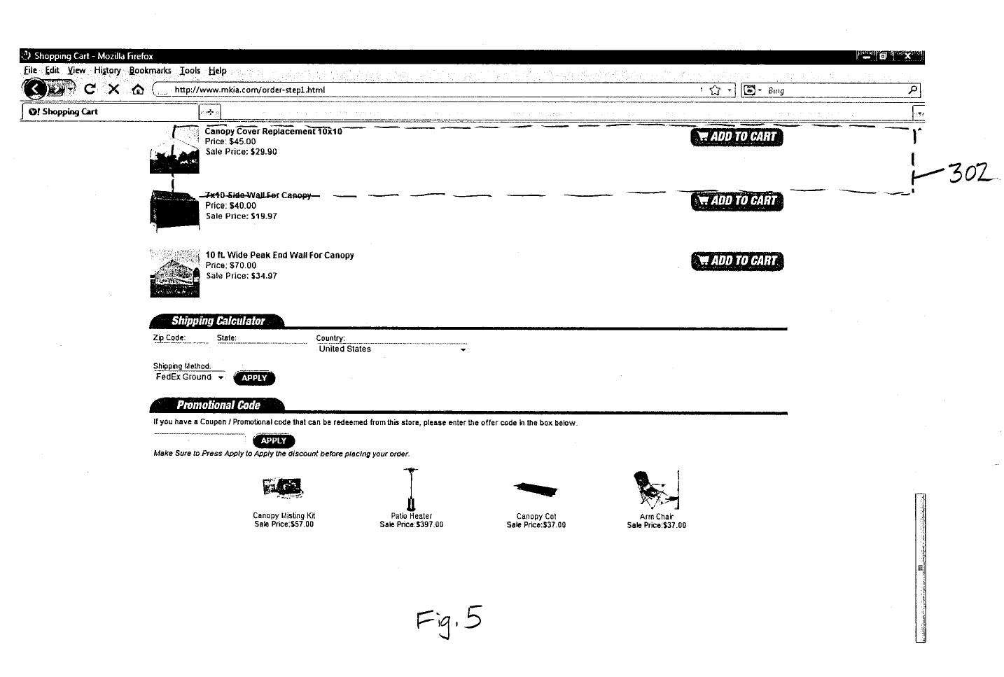

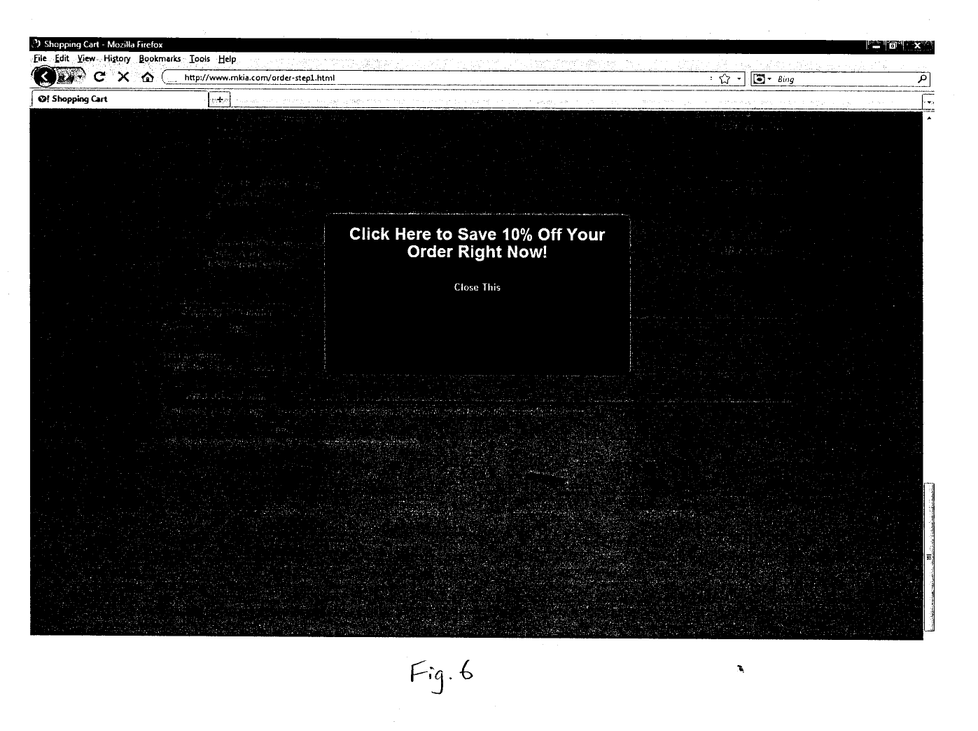

The hidden area 302 in one embodiment dynamically moves with the location on the page. That is, some pages are larger than can be presented on a user video display such as a monitor or the like. To view portions of pages that are not initially viewable on the screen, the user scrolls, using a mouse wheel, scroll bar on the web page, or the like to move around the page. In one embodiment, when a user scrolls down a web page, the hidden area 302 changes location on the page with the scrolling. FIG. 5 shows the position of hidden area 302 on a page that has been scrolled down to near the bottom of the page. When the user moves the cursor over the hidden area 302 as positioned in FIG. 5, the resulting message displayed is shown in FIG. 6.

It should be understood that programming of the hidden area and the hyperlink are capable of being performed in a number of ways without departing from the scope of the disclosure. For example, the hidden area can be created, by way of example only and not by way of limitation, using hyper text markup language (HTML), cascading style sheets (CSS), Javascript, and other markup languages. The hidden area hyperlink can be activated, by way of example only and not by way of limitation, using the onMouseOver tag in Javascript.

In operation, one embodiment of a method according to the present disclosure operates as follows. A user enters a URL to a web site. The user decides on an item or items for possible purchase, or for a service available on that web site. When the user gets to the web page that handles the online transaction (e.g., shopping cart, checkout pages, sign up form page) for the web site, if the user decides not to complete the transaction, as indicated by moving the pointing device toward a location which would allow the closing of the web page, for whatever reason, before the user can get to the close (X) on the browser, the address bar of the browser to enter a new URL, or any place on the browser to close out the session or to start a new session, the user rolls over the hidden area such as area 302 containing the hyperlink to the message such as message 402. The message 402 is displayed, or the user is contacted in the form of a pop-up window, telephone call, e-mail, or the like containing an incentive to stay on the web page or to go back to the web page and possibly complete the on-line transaction.

A method 600 according to one embodiment of the disclosure is shown in flow chart form in FIG. 6. Method 600 comprises programming a hidden area on a web page in the path or paths of exit from the browser or web page in block 702, and activating a hyperlink associated with the hidden area when a pointing device enters the hidden area in block 704. The hyperlink in one embodiment displays a message such as that described herein. In one embodiment, the hidden area is re-positioned in the path or paths of exit from the browser or web page to different locations on the page depending upon the position of scrolling on the page.

Various examples of the present disclosure may be embodied in a computer program product, which may include computer readable program code embodied thereon, the code executable to implement a method of maintaining a database of patch data. The computer readable program code may take the form of machine-readable instructions. These machine-readable instructions may be stored in a memory, such as a computer-usable medium, and may be in the form of software, firmware, hardware, or a combination thereof. The machine-readable instructions configure a computer to perform various methods of thread balancing and allocation, such as described herein in conjunction with various embodiments of the disclosure.

In a hardware solution, the computer-readable instructions are hard coded as part of a processor, e.g., an application-specific integrated circuit (ASIC) chip. In a machine-readable instruction solution, the instructions are stored for retrieval by the processor. Some additional examples of computer-usable media include static or dynamic random access memory (SRAM or DRAM), read-only memory (ROM), electrically erasable programmable ROM (EEPROM or flash memory), magnetic media and optical media, whether permanent or removable. Most consumer-oriented computer applications are machine-readable instruction solutions provided to the user on some form of removable computer-usable media, such as a compact disc read-only memory (CD-ROM) or digital video disc (DVD). Alternatively, such computer applications may be delivered electronically, such as via the Internet or the like.

It will be appreciated that embodiments of the present disclosure can be realized in the form of hardware, machine-readable instructions, or a combination of hardware and machine-readable instructions. Any such set of machine-readable instructions may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement embodiments of the present disclosure. Accordingly, embodiments provide a program comprising code for implementing a system or method and a machine readable storage storing such a program. Still further, embodiments of the present disclosure may be conveyed electronically via any medium such as a communication signal carried over a wired or wireless connection and embodiments suitably encompass the same.

FIG. 8 is a representation of a computer system 800 for use with various embodiments of the disclosure. The computer system 800 includes a processor 802 connected to and capable of communication with a computer readable memory 804. Computer-readable storage medium 806 is in communication with system 800.

Computer-readable storage media in various embodiments may include different forms of memory or storage, including by way of example semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs).

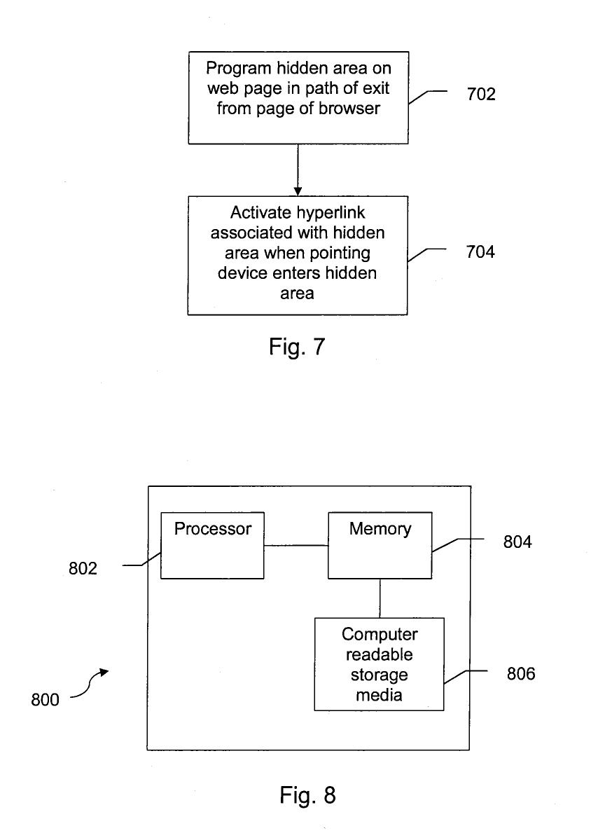

Computer-readable storage media can be internal or external to the system 800, and in various embodiments contains a computer program product having machine-readable instructions stored thereon adapted to cause the processor 802 to perform one or more methods described above with respect to FIGS. 1-7.

### CONCLUSION

Systems and methods have been described that include programming a hidden area of a web page in the path of exit from the web page or browser, and activating a hyperlink to provide a user incentive to complete an online transaction when the user pointing device enters the hidden area. The hidden area can move with scrolling of the web page.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of preventing termination of an online transaction, comprising:
identifying a potential transaction terminating event prior to an actual terminating event; and
offering a user an incentive to complete the online transaction.

2. The method of claim 1, wherein identifying further comprises:
identifying an area within a web page that is an exit path from the web page or browser; and
embedding a hyperlink to the incentive to complete the online transaction, the hyperlink activating upon passing of a pointing device into the area.

3. The method of claim 2, wherein the area is re-positioned within the web page when the web page is scrolled to a different location within the page.

4. The method of claim 2, wherein the area is a hidden area.

5. A method of preventing termination of an online transaction, comprising:
programming a hidden area on a web page in a path of exit from the web page; and
activating a hyperlink associated with the hidden area when a pointing device enters the hidden area.

6. The method of claim 5, wherein the hidden area is re-positioned within the web page when the web page is scrolled to a different location within the page.

7. A computer program product, comprising a computer usable medium having a computer readable program code embodied therein, the computer readable program code adapted to implement a method for preventing termination of an online transaction by programming a hidden area on a web page in a path of exit from the web page, and activating a hyperlink associated with the hidden area when a pointing device enters the hidden area.

8. A computer system, comprising:
a processor;
a memory; and
a computer program product, comprising a computer usable medium having a computer readable program code embodied therein, the computer readable program code adapted to implement a method for preventing termination of an online transaction by programming a hidden area on a web page in a path of exit from the web page, and activating a hyperlink associated with the hidden area when a pointing device enters the hidden area.
